(19) United States
(12) Patent Application Publication
(10) Pub. No.: US 2023/0183955 A1
(43) Pub. Date: Jun. 15, 2023

(54) MISOPERATION PREVENTION STRUCTURE OF TWO-HANDLE FAUCET

(71) Applicant: Xiamen Forbetter Sanitary Ware Co., Ltd., Xiamen (CN)

(72) Inventors: Xingui Zhang, Xiamen (CN); Mouyong Lin, Xiamen (CN); Jin Guo, Xiamen (CN)

(21) Appl. No.: 17/547,255

(22) Filed: Dec. 10, 2021

(51) Int. Cl. E03C 1/04; F16K 31/60

(52) U.S. Cl. CPC E03C 1/0412; F16K 31/602

(57) ABSTRACT

A misoperation prevention structure of a two-handle faucet includes a faucet spout and two switching valves for controlling water to be delivered to the faucet spout. At least one of the two switching valves is equipped with a misoperation prevention mechanism. The misoperation prevention mechanism is configured to restrict the rotation of the handle of the switching valve and to release the restriction on the rotation of the handle of the switching valve. With the misoperation prevention mechanism, the switching valve won't be opened by mistake, thereby avoiding a waste of water resources and improving the safety of use.

### BACKGROUND OF THE INVENTION

### 1. Field of the Invention

The present invention relates to a faucet, and more particularly to a misoperation prevention structure of a two-handle faucet.

### 2. Description of the Prior Art

A conventional two-handle faucet has two switching valves for adjusting the mixing ratio of cold and hot water, thereby adjusting the temperature of water flowing out of the spout of the faucet. However, for the conventional two-handle faucet, the handle of the switching valve can be directly turned to flow water out. The handle is prone to cause uncontrollable rotation due to external misoperation, which causes the switching valve to open incorrectly. This will result in a waste of water resources. In addition, if the handle of the switching valve for controlling hot water is operated by mistake to open the switching valve for controlling hot water incorrectly, it is easy to cause hot water to scald the user, and there is a certain safety hazard.

### SUMMARY OF THE INVENTION

In view of the deficiencies of the prior art, the primly object of the present invention is to provide a misoperation prevention structure of a two-handle faucet, which can avoid a waste of water resources.

In order to achieve the above object, the present invention adopts the following technical solutions:

A misoperation prevention structure of a two-handle faucet comprises a faucet spout and two switching valves for controlling water to be delivered to the faucet spout. At least one of the two switching valves is equipped with a misoperation prevention mechanism. The switching valve equipped with the misoperation prevention mechanism is defined as a safety switching valve. The safety switching valve includes a switching valve seat, a switching valve core, a handle, and the misoperation prevention mechanism. The handle, the switching valve core and the switching valve seat are arranged in sequence in an upper-to-lower direction. The switching valve core is mounted to the switching valve seat. The handle is connected to a valve stem of the switching valve core. The handle and the valve stem of the switching valve core rotate in synchronization with each other. The misoperation prevention mechanism includes a limit member that is not rotatable relative to a valve housing of the switching valve core and an operating member that is movably fitted to the handle. The operating member is in movable cooperation with the limit member.

In an embodiment of the present invention, the handle is formed with a mounting hole. The operating member is slidably connected to the mounting hole. The operating member is movable between a limit position and a release position. The operating member is provided with a rotation stopper that is in movable cooperation with the limit member. When the operating member is moved to the limit position, the rotation stopper of the operating member cooperates with the limit member to form a rotation limit. When the operating member is moved to the release position, the rotation stopper of the operating member cooperates with the limit member to release the rotation limit A return spring is fitted between the handle and the operating member. The return spring is configured to drive the operating member to move to the limit position.

In an embodiment of the present invention, the mounting hole of the handle is disposed on a side wall of the handle. The operating member is slidably connected to the mounting hole to be moved up and down. The limit member is arranged lower than the operating member. Upper and lower ends of the return spring abut against the handle and the operating member, respectively.

In an embodiment of the present invention, the mounting hole of the handle is disposed on a side wall of the handle. The operating member is slidably connected to the mounting hole. The operating member is movable along an axial direction of the mounting hole. Inner and outer ends of the return spring abut against the handle and the operating member, respectively.

Preferably, an inside of the handle is provided with a connecting portion connected to the valve stein of the switching valve core. The inner and outer ends of the return spring abut against the connecting portion of the handle and the operating member, respectively.

In an embodiment of the present invention, the mounting hole of the handle is disposed on a top of the handle. The operating member is slidably connected to the mounting hole to be moved up and down. The limit member is arranged lower than the operating member. Upper and lower ends of the return spring abut against the operating member and the handle, respectively.

Preferably, the limit member is formed with an arc groove for the rotation stopper to slide in the arc groove. When the operating member is moved down to the release position, the rotation stopper of the operating member faces the arc groove.

Preferably, an inside of the handle is provided with a connecting portion connected to the valve stein of the switching valve core. The upper and lower ends of the return spring abut against the operating member and the connecting portion of the handle, respectively.

Preferably, the return spring is a conical spring.

Preferably, the limit member is fixedly disposed on the valve housing of the switching valve core.

Preferably, the limit member is fixedly disposed on a top of the valve housing of the switching valve core.

Preferably, the safety switching valve further includes a retaining cover. The retaining cover is threadedly connected to an externally threaded sleeve and presses the switching valve seat for installing the switching valve seat to the externally threaded sleeve. The limit member is fixedly disposed on the retaining cover.

Preferably, the two switching valves and the faucet spout are installed on a casing. The limit member is fixedly disposed on the casing.

After adopting the above solutions, at least one of the two switching valves of the two-handle faucet of the present invention is defined as a safety switching valve. The safety switching valve is equipped with a misoperation prevention mechanism. When the safety switching valve is in a closed state, the misoperation prevention mechanism is configured to restrict the rotation of the handle of the safety switching valve. At this time, when the handle of the safety switching valve is operated, the handle will not turn, thereby preventing the safety switching valve from being opened by mistake and avoiding a waste of water resources because the safety switching valve is opened by mistake. In addition, the present invention can set the switching valve used to control hot water as a safety switching valve. In this way, the wrong output of hot water can be avoided, thereby preventing hot water output by mistake from scalding the user, so as to improve the safety of use.

### BRIEF DESCRIPTION OF THE DRAWINGS

FIG. 1 is a schematic view according to a first embodiment of the present invention;

FIG. 2 is an exploded view of the safety switching valve according to the first embodiment of the present invention;

FIG. 3 is a schematic view of the safety switching valve according to the first embodiment of the present invention;

FIG. 4 is a partial view of the safety switching valve according to the first embodiment of the present invention;

FIG. 5 is a cross-sectional view of the safety switching valve according to the first embodiment of the present invention;

FIG. 6 is an exploded view of the safety switching valve according to a second embodiment of the present invention;

FIG. 7 is a schematic view of the safety switching valve according to the second embodiment of the present invention;

FIG. 8 is a partial view of the safety switching valve according to the second embodiment of the present invention;

FIG. 9 is a cross-sectional view of the safety switching valve according to the second embodiment of the present invention;

FIG. 10 is an exploded view of the safety switching valve according to a third embodiment of the present invention;

FIG. 11 is a partial view of the safety switching valve according to the third embodiment of the present invention;

FIG. 12 is a first sectional view of the safety switching valve according to the third embodiment of the present invention;

FIG. 13 is a second sectional view of the safety switching valve according to the third embodiment of the present invention;

FIG. 14 is an exploded view of the safety switching valve according to a fourth embodiment of the present invention;

FIG. 15 is a partial view of the safety switching valve according to the fourth embodiment of the present invention;

FIG. 16 is a cross-sectional view of the safety switching valve according to the fourth embodiment of the present invention;

FIG. 17 is an exploded view of the partial structure of a fifth embodiment of the present invention;

FIG. 18 is a schematic view of the partial structure of the fifth embodiment of the present invention;

FIG. 19 is a cross-sectional view of the partial structure of the fifth embodiment of the present invention;

FIG. 20 is an exploded view of the safety switching valve according to a sixth embodiment of the present invention;

FIG. 21 is a schematic view of the safety switching valve according to the sixth embodiment of the present invention;

FIG. 22 is a partial schematic view of the safety switching valve according to the sixth embodiment of the present invention;

FIG. 23 is a cross-sectional view of the safety switching valve according to the sixth embodiment of the present invention;

FIG. 24 is a schematic view according to a seventh embodiment of the present invention;

FIG. 25 is an exploded view according to the seventh embodiment of the present invention;

FIG. 26 is a partial schematic view according to the seventh embodiment of the present invention; and

FIG. 27 is a cross-sectional view of the safety switching valve according to the seventh embodiment of the present invention.

### DETAILED DESCRIPTION OF THE PREFERRED EMBODIMENTS

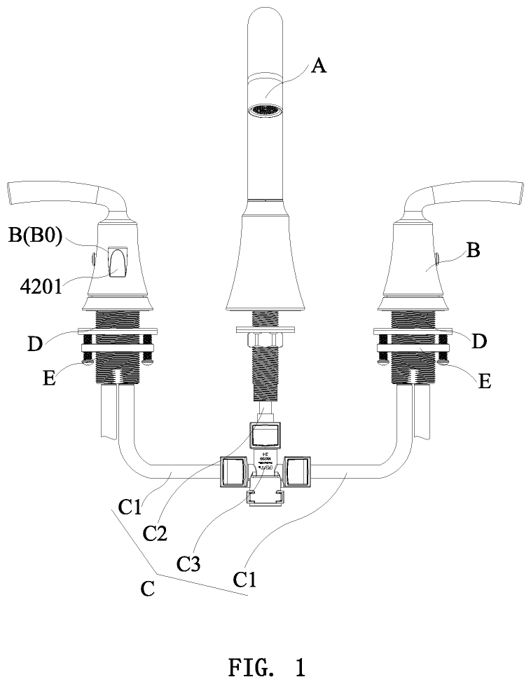

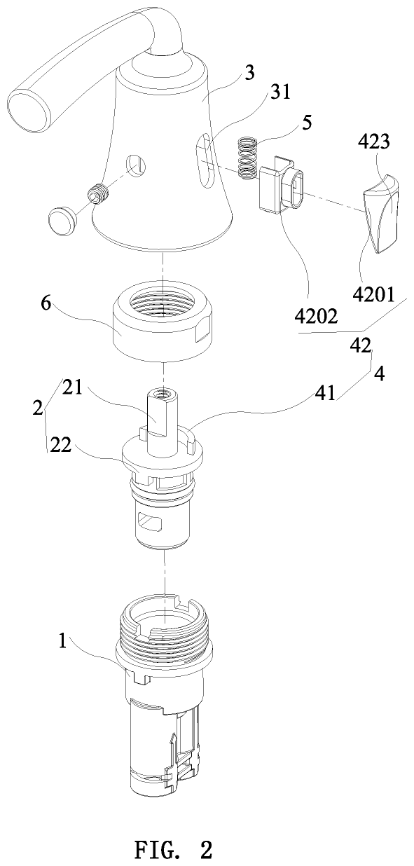

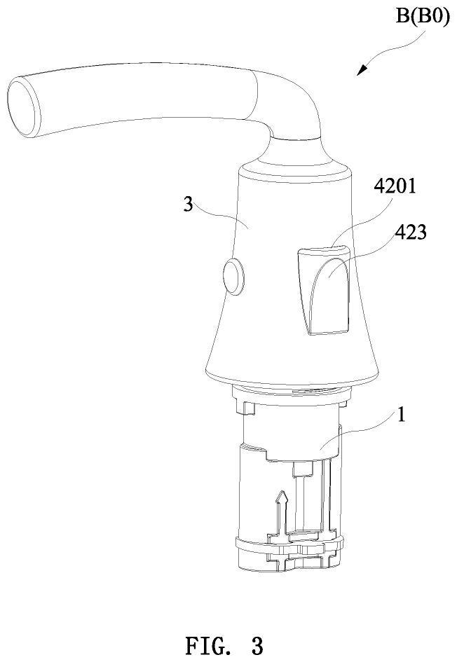

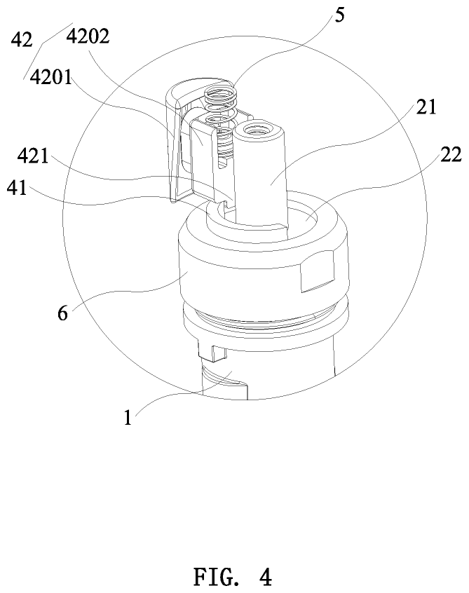

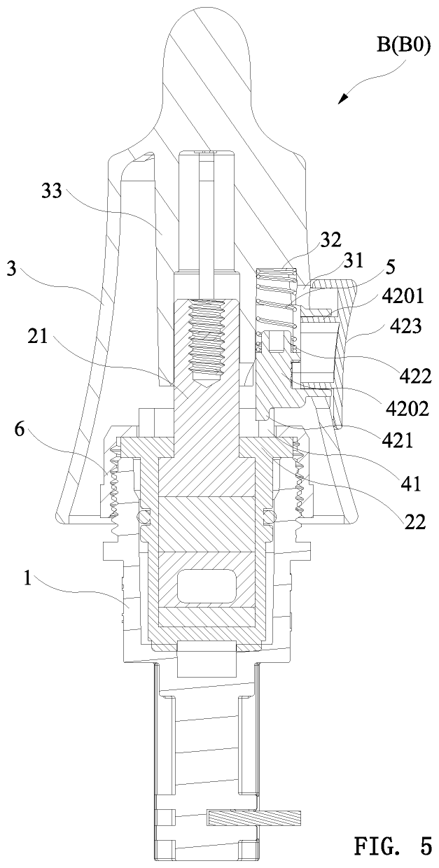

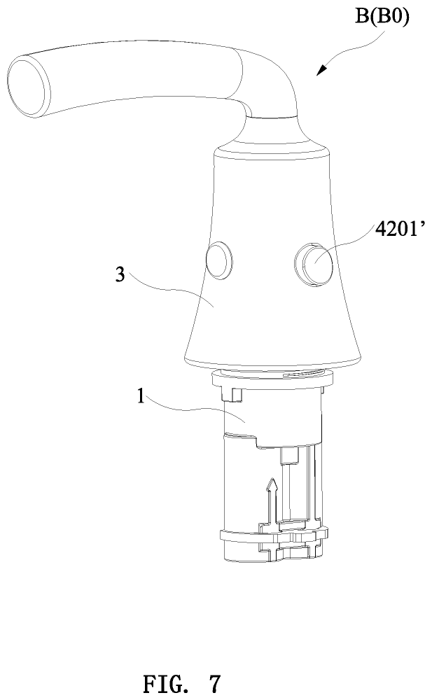

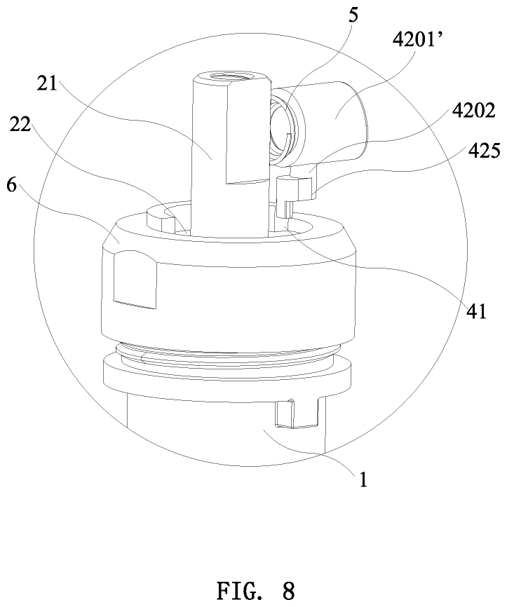

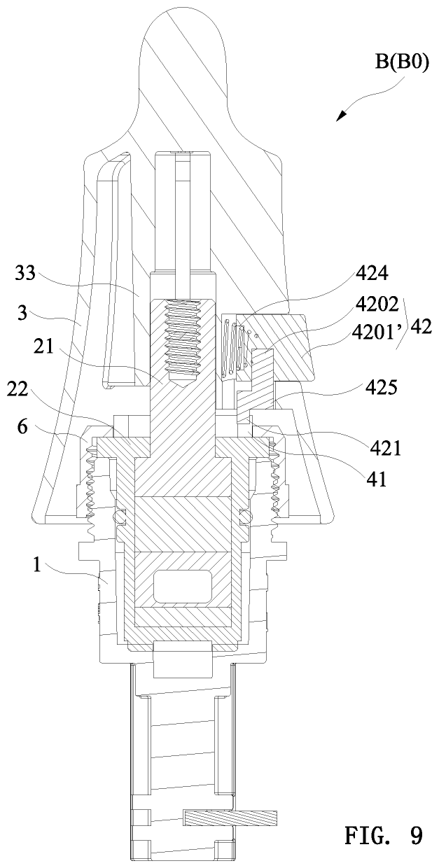

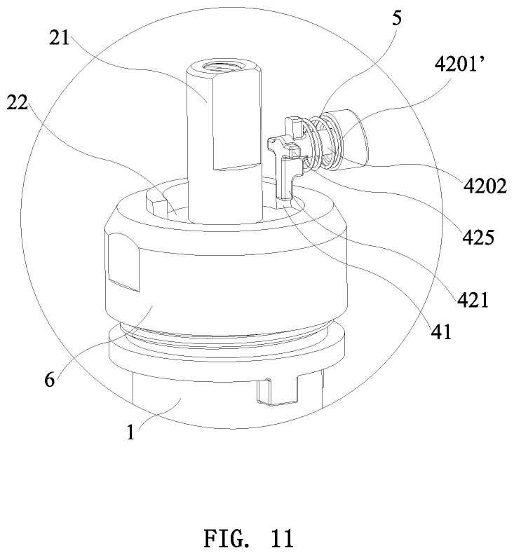

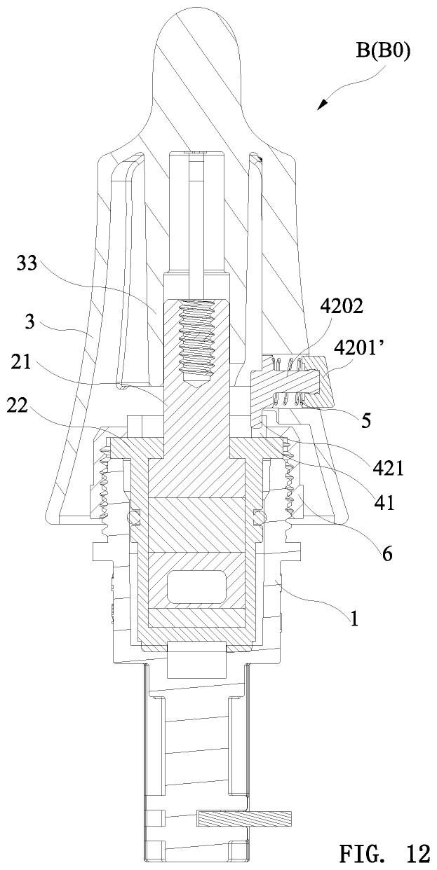

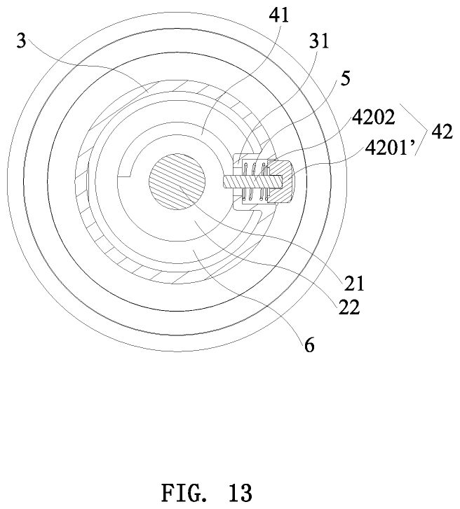

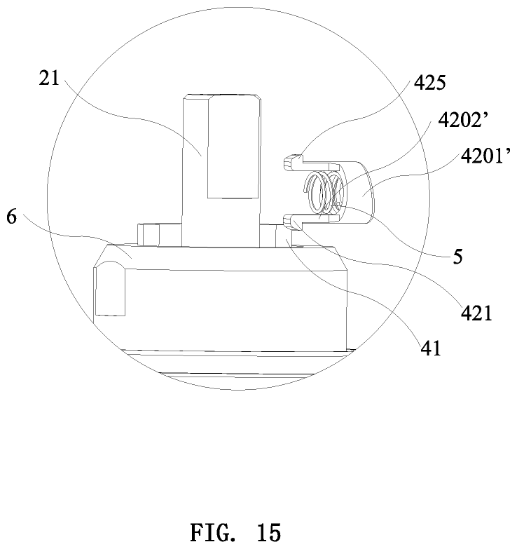

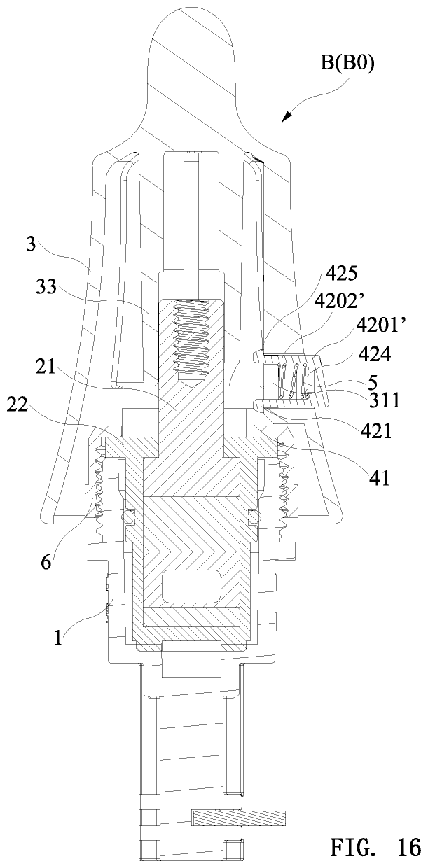

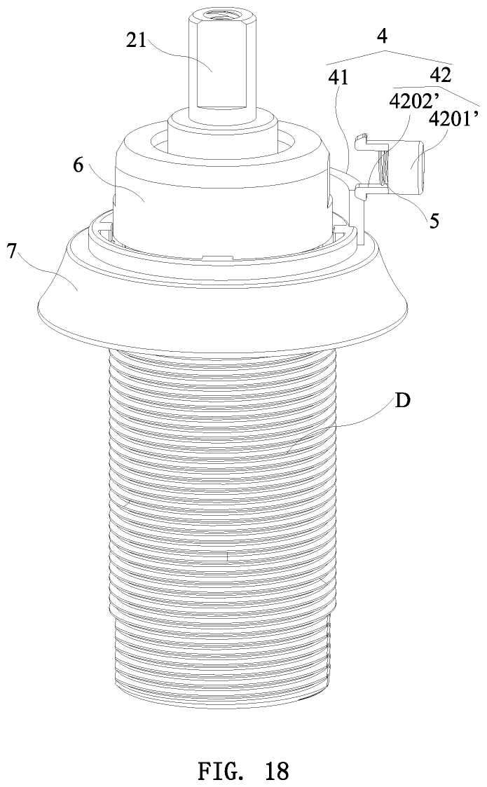

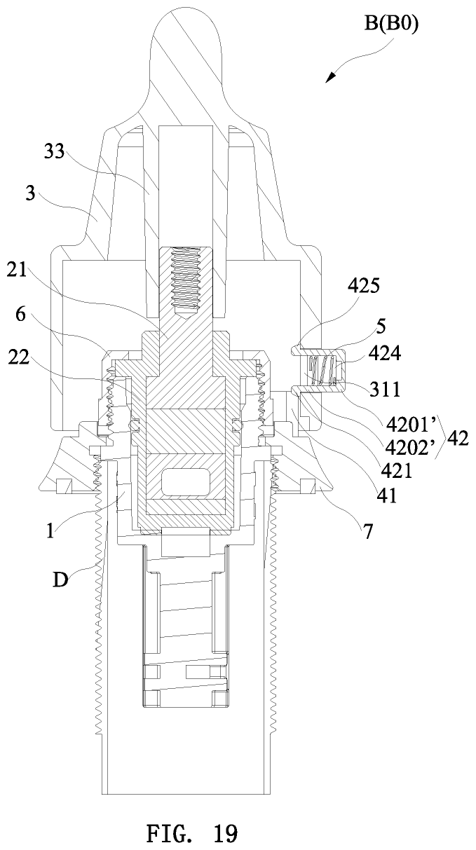

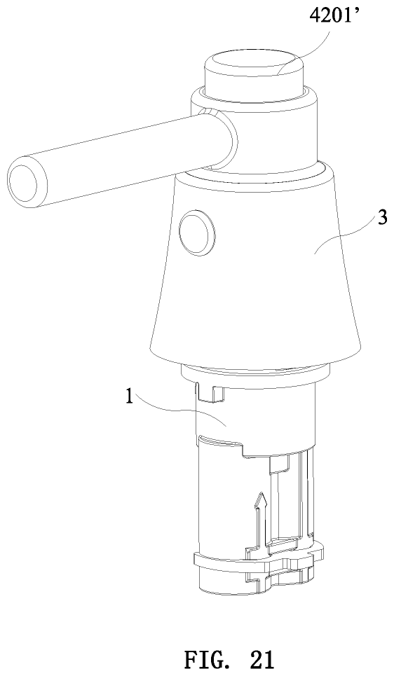

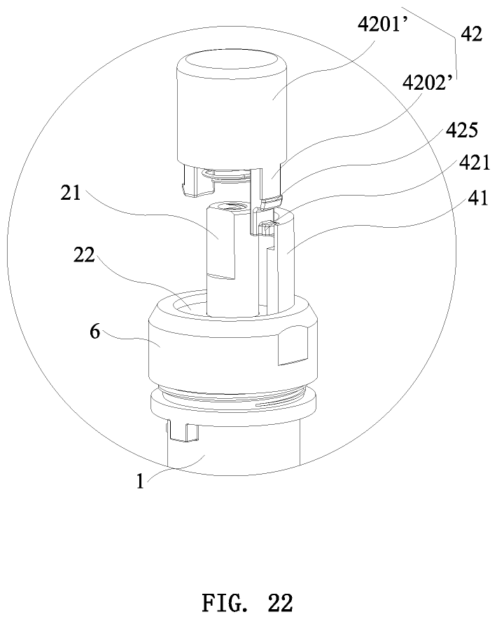

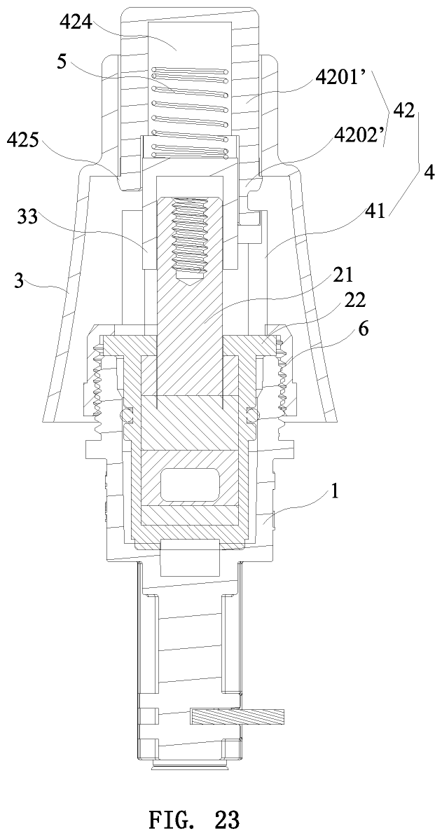

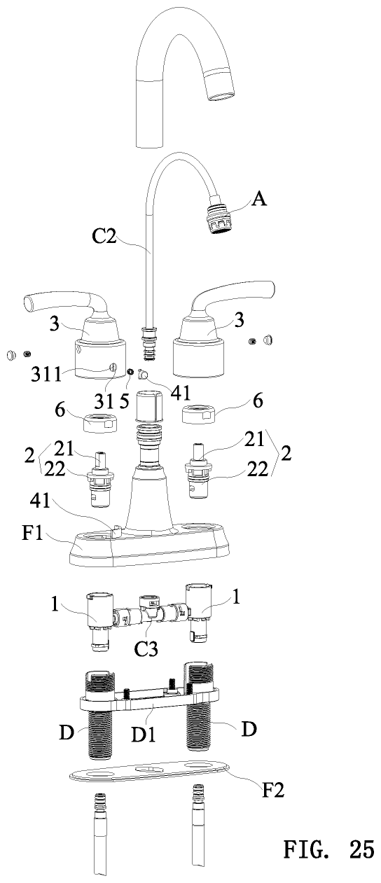

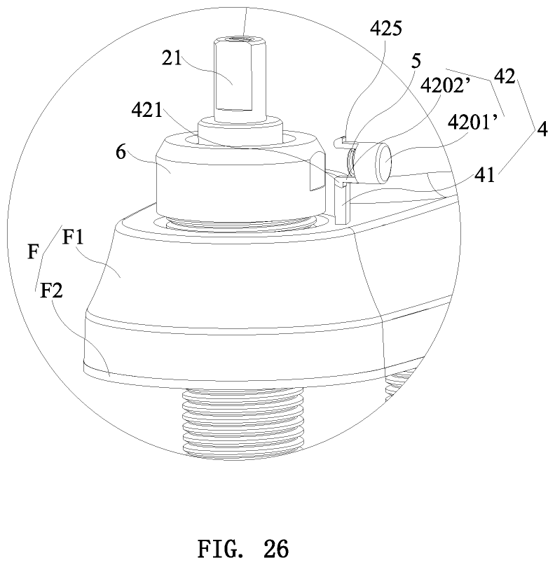

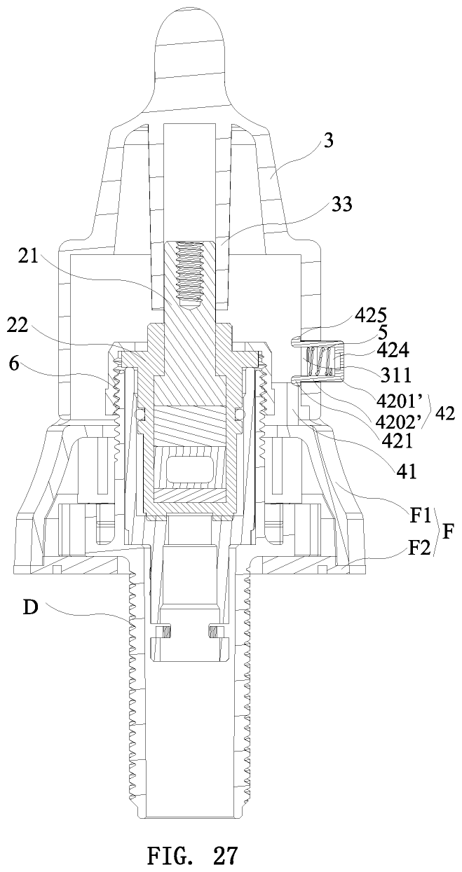

As shown in FIG. 1 through FIG. 27, the present invention discloses a misoperation prevention structure of a two-handle faucet, comprising a faucet spout A and two switching valves B for controlling water to be delivered to the faucet spout A. The two switching valves B are connected to the faucet spout A through a water delivery member C. The water delivery member C may include a three-way connector C3. The outlet ends of the two switching valves B are connected to two inlets of the three-way connector C3, respectively. The inlet end of the faucet spout A is connected to the outlet of the three-way connector C3.

The feature of the present invention is that at least one of the two switching valves B is equipped with a misoperation prevention mechanism 4. The switching valve B equipped with the misoperation prevention mechanism 4 is defined as a safety switching valve B0. The misoperation prevention mechanism 4 is configured to restrict the rotation of the handle 3 of the safety switching valve B0 and to release the restriction on the rotation of the handle 3 of the safety switching valve B0.

The safety switching valve B0 of the present invention is equipped with the misoperation prevention mechanism 4, so that when the safety switching valve B0 is in a closed state, the misoperation prevention mechanism 4 is configured to restrict the rotation of the handle 3 of the safety switching valve B0. At this time, when the handle 3 of the safety switching valve B0 is operated, the handle 3 will not turn, thereby preventing the safety switching valve B0 from being opened by mistake and avoiding a waste of water resources because the safety switching valve B0 is opened by mistake. In addition, the present invention can set the switching valve B used to control hot water as the safety switching valve B0. In this way, the wrong output of hot water can be avoided, thereby preventing hot water output by mistake from scalding the user, so as to improve the safety of use. When it is necessary to turn the handle 3 of the safety switching valve B0, the user can release the restriction on the rotation of the handle 3 of the safety switching valve B0 by the misoperation prevention mechanism 4, and then the handle 3 can be turned.

In the present invention, the safety switching valve B0 includes a switching valve seat 1, a switching valve core 2, the handle 3, and the misoperation prevention mechanism 4. The handle 3, the switching valve core 2 and the switching valve seat 1 are arranged in sequence in an upper-to-lower direction. The switching valve core 2 is mounted to the switching valve seat 1. The handle 3 is connected to a valve stein 21 of the switching valve core 2. The handle 3 and the valve stein 21 of the switching valve core 2 rotate in synchronization with each other. The misoperation prevention mechanism 4 includes a limit member 41 that is not rotatable relative to a valve housing 22 of the switching valve core 2 and an operating member 42 that is movably fitted to the handle 3. The operating member 42 is in movable cooperation with the limit member 41, so that the misoperation prevention mechanism 4 can restrict the rotation of the handle 3 of the safety switching valve B0 and release the restriction on the rotation of the handle 3 of the safety switching valve B0.

In the present invention, the handle 3 may be formed with a mounting hole 31. The operating member 42 is slidably connected to the mounting hole 31, and the operating member 42 is movable between a limit position and a release position. The operating member 42 is provided with a rotation stopper 421 that is in movable cooperation with the limit member 41. When the operating member 42 is moved to the limit position, the rotation stopper 421 of the operating member 42 cooperates with the limit member 41 to form a rotation limit, thereby restricting the rotation of the handle 3 of the safety switching valve B0. When the operating member 42 is moved to the release position, the rotation stopper 421 of the operating member 42 cooperates with the limit member 41 to release the rotation limit, thereby releasing the restriction on the rotation of the handle 3 of the safety switching valve B0. A return spring 5 is fitted between the handle 3 and the operating member 42. The return spring 5 is located in the handle 3 and is configured to drive the operating member 42 to move to the limit position. In this way, when the safety switching valve B0 is in a closed state, the operating member 42 can automatically move to the limit position, thereby preventing the safety switching valve B0 from being opened by mistake.

In the present invention, the switching valve B may be installed on an externally threaded sleeve D. The externally threaded sleeve D may be fixed to a basin countertop through mounting nuts E, and the switching valve B is mounted to a basin. The switching valve core 2 may be restricted on the switching valve seat 1 by a valve cover 6.

Embodiments of the present invention will now be described, by way of example only, with reference to the accompanying drawings.

### First Embodiment

As shown in FIGS. 1 to 5, in the first embodiment of the present invention, the mounting hole 31 of the handle 3 is disposed on the side wall of the handle 3. The operating member 42 is slidably connected to the mounting hole 31 to be moved up and down. The limit member 41 is arranged lower than the operating member 42. The upper and lower ends of the return spring 5 abut against the handle 3 and the operating member 42, respectively. Through the arrangement of the present invention, the limit position is lower than the release position, and the operating member 42 can be moved up and down to be switched between the limit position and the release position. The return spring 5 can drive the operating member 42 to move down to the limit position.

In the first embodiment of the present invention, the inside of the handle 3 is formed with a spring confining groove 32 with a downward opening. The operating member 42 is provided with a spring confining post 422. The upper end of the return spring 5 is inserted into the spring confining groove 32, and the lower end of the return spring 5 is sleeved on the spring confining post 422. In this way, the spring confining groove 32 and the spring confining post 422 limit the return spring 5 to prevent the return spring 5 from disengagement.

In the first embodiment of the present invention, the operating member 42 may include a button 4201 and an engaging block 4202. In this way, the operating member 42 is divided into two parts to facilitate the operating member 42 to be mounted to the handle 3. The button 4201 may be insertedly connected to the engaging block 4202. The button 4201 has a slide portion 423 located outside the handle 3 for the user to move the operating member 42 up and down. The engaging block 4202 has the rotation stopper 421 and the spring confining post 422. The lower end of the return spring 5 abuts against the engaging block 4202.

In the first embodiment of the present invention, the limit member 41 is fixedly disposed on the top of the valve housing 22 of the switching valve core 2. In this way, the occupation of the lateral space of the limit member 41 and the operating member 42 is reduced, and the lateral size of the safety switching valve B0 is reduced. The limit member 41 may be integrally formed with the top of the valve housing 22. In this way, there is no need to provide an assembly structure between the limit member 41 and the valve housing 22, thereby simplifying the structure of the safety switching valve B0 and improving the assembly efficiency of the safety switching valve B0. It should be noted that the limit member 41 of the present invention may be integrally formed with the switching valve seat 1. This also simplifies the structure of the safety switching valve B0 and improves the assembly efficiency of the safety switching valve B0.

In the first embodiment of the present invention, the water delivery member C further includes two inlet pipes C1 and one outlet pipe C2. The outlet ends of the two switching valves B are connected to the two inlets of the three-way connector C3 through the two inlet pipes C1, respectively. The inlet end of the faucet spout A is connected to the outlet of the three-way connector C3 through the outlet pipe C2.

In the first embodiment of the present invention, the valve cover 6 is connected to the switching valve seat 1 and presses the switching valve core 2 so as to confine the switching valve core 2 on the switching valve seat 1. The valve cover 6 may be threadedly connected to the switching valve seat 1. The valve stem 21 of the switching valve core 2 passes through the valve cover 6.

### Second Embodiment

The main difference between the second embodiment of the present invention and the first embodiment lies in the structural difference of the safety switching valve B0.

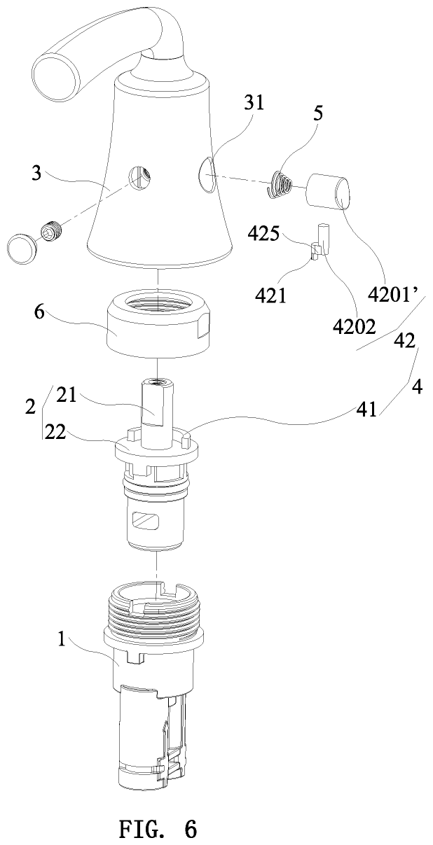

Specially, as shown in FIGS. 6 to 9, in the second embodiment of the present invention, the mounting hole 31 of the handle 3 is disposed on the side wall of the handle 3. The operating member 42 is slidably connected to the mounting hole 31. The operating member 42 is movable along the axial direction of the mounting hole 31. The inner and outer ends of the return spring 5 abut against the handle 3 and the operating member 42, respectively. Through the arrangement of the present invention, the operating member 42 is movable along the axial direction of the mounting hole 31 to be switched between the limit position and the release position. The return spring 5 can drive the operating member 42 to move to the limit position.

In the second embodiment of the present invention, the inside of the handle 3 is provided with a connecting portion 33 connected to the valve stein 21 of the switching valve core 2. The connecting portion 33 is fixed to the valve stein 21 of the switching valve core 2 by a screw. The inner and outer ends of the return spring 5 abut against the connecting portion 33 of the handle 3 and the operating member 42, respectively.

In the second embodiment of the present invention, the operating member 42 may include a button 4201′ and an engaging block 4202 that are connected. In this way, the operating member 42 is divided into two parts to facilitate the operating member 42 to be mounted to the handle 3. The inner and outer ends of the return spring 5 abut against the connecting portion 33 of the handle 3 and the inner end of the button 4201′, respectively. The inner end of the button 4201′ may be formed with a spring engaging groove 424 to receive the outer end of the return spring 5, so as to prevent the return spring 5 from shifting. The engaging block 4202 is insertedly connected to the button 4201′. The engaging block 4202 has the rotation stopper 421. In addition, the operating member 42 may be provided with a stop block 425 to abut against the inner side of the side wall of the handle 3, so as to prevent the operating member 42 from being separated from the handle 3. The stop block 425 may be disposed on the engaging block 4202.

In the second embodiment of the present invention, the limit member 41 is fixedly disposed on the top of the valve housing 22 of the switching valve core 2. The limit member 41 may be integrally formed with the top of the valve housing 22.

In the second embodiment of the present invention, the return spring 5 is a conical spring. The minimum compressed thickness of the conical spring is the diameter of the conical spring. In this way, the minimum compressed thickness of the conical spring is small, which is beneficial to reduce the installation space of the conical spring in the handle 3 and to reduce the size of the safety switching valve B0.

### Third Embodiment

The main difference between the third embodiment of the present invention and the first embodiment lies in the structural difference of the safety switching valve B0.

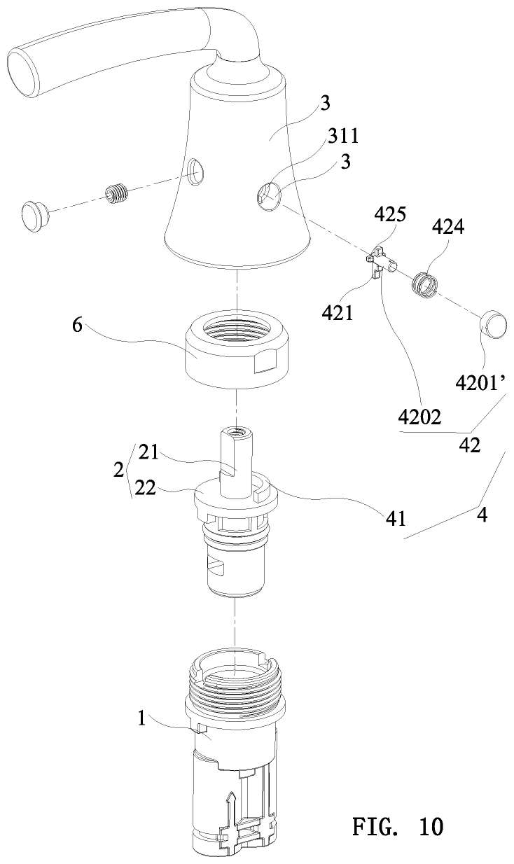

Specially, as shown in FIGS. 10 to 13, in the third embodiment of the present invention, the mounting hole 31 of the handle 3 is disposed on the side wall of the handle 3. The operating member 42 is slidably connected to the mounting hole 31. The operating member 42 is movable along the axial direction of the mounting hole 31. The inner and outer ends of the return spring 5 abut against the handle 3 and the operating member 42, respectively. Through the arrangement of the present invention, the operating member 42 is movable along the axial direction of the mounting hole 31 to be switched between the limit position and the release position. The return spring 5 can drive the operating member 42 to move to the limit position.

In the third embodiment of the present invention, the inner wall of the mounting hole 31 of the handle 3 is provided with a stop edge 311. The inner and outer ends of the return spring 5 abut against the stop edge 311 and the operating member 42, respectively.

In the third embodiment of the present invention, the operating member 42 may include a button 4201′ and an engaging block 4202 that are connected. In this way, the operating member 42 is divided into two parts to facilitate the operating member 42 to be mounted to the handle 3. The inner and outer ends of the return spring 5 abut against the stop edge 311 of the handle 3 and the button 4201′, respectively. The return spring 5 may be sleeved on the engaging block 4202 of the operating member 42 to prevent the return spring 5 from shifting. The engaging block 4202 is connected to the button 4201′ in a snap-on manner. The engaging block 4202 has the rotation stopper 421. In addition, the operating member 42 may be provided with a stop block 425 to abut against the inner side of the side wall of the handle 3, so as to prevent the operating member 42 from being separated from the handle 3. The stop block 425 may be disposed on the engaging block 4202.

In the third embodiment of the present invention, the limit member 41 is fixedly disposed on the top of the valve housing 22 of the switching valve core 2. The limit member 41 may be integrally formed with the top of the valve housing 22.

### Fourth Embodiment

The main difference between the fourth embodiment of the present invention and the first embodiment lies in the structural difference of the safety switching valve B0.

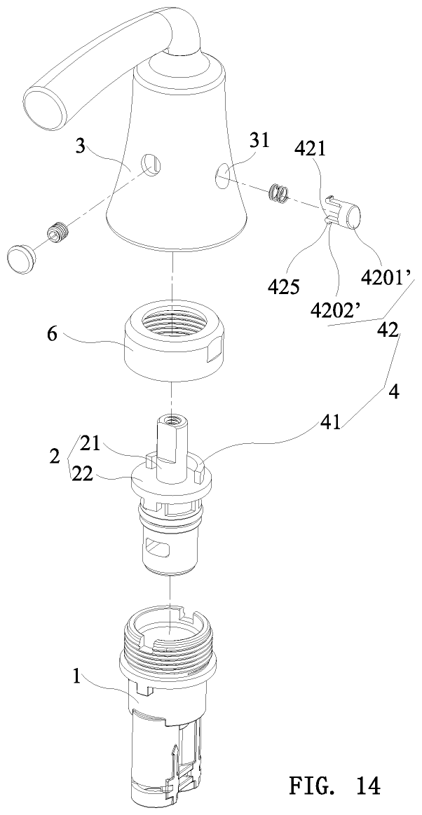

Specially, as shown in FIGS. 14 to 16, in the fourth embodiment of the present invention, the mounting hole 31 of the handle 3 is disposed on the side wall of the handle 3. The operating member 42 is slidably connected to the mounting hole 31. The operating member 42 is movable along the axial direction of the mounting hole 31. The inner and outer ends of the return spring 5 abut against the handle 3 and the operating member 42, respectively. Through the arrangement of the present invention, the operating member 42 is movable along the axial direction of the mounting hole 31 to be switched between the limit position and the release position. The return spring 5 can drive the operating member 42 to move to the limit position.

In the fourth embodiment of the present invention, the inner wall of the mounting hole 31 of the handle 3 is provided with a stop edge 311. The inner and outer ends of the return spring 5 abut against the stop edge 311 and the operating member 42, respectively.

In the fourth embodiment of the present invention, the operating member 42 may include a button 4201′ and an engaging claw 4202′ that are connected. In this way, the operating member 42 is divided into two parts to facilitate the operating member 42 to be mounted to the handle 3. The inner and outer ends of the return spring 5 abut against the stop edge 311 of the handle 3 and the button 4201′, respectively. The button 4201′ may be formed with a spring engaging groove 424 to receive the outer end of the return spring 5, so as to prevent the return spring 5 from shifting. The engaging claw 4202′ may include two engaging claws 4202′. The end of one of the engaging claws 4202′ is provided with the rotation stopper 421. The engaging claws 4202′ may be integrally formed with the button 4201′. In addition, the operating member 42 may be provided with a stop block 425 to abut against the inner side of the side wall of the handle 3, so as to prevent the operating member 42 from being separated from the handle 3. The stop block 425 may be disposed on the engaging claw 4202′.

In the fourth embodiment of the present invention, the limit member 41 is fixedly disposed on the top of the valve housing 22 of the switching valve core 2. The limit member 41 may be integrally formed with the top of the valve housing 22.

### Fifth Embodiment

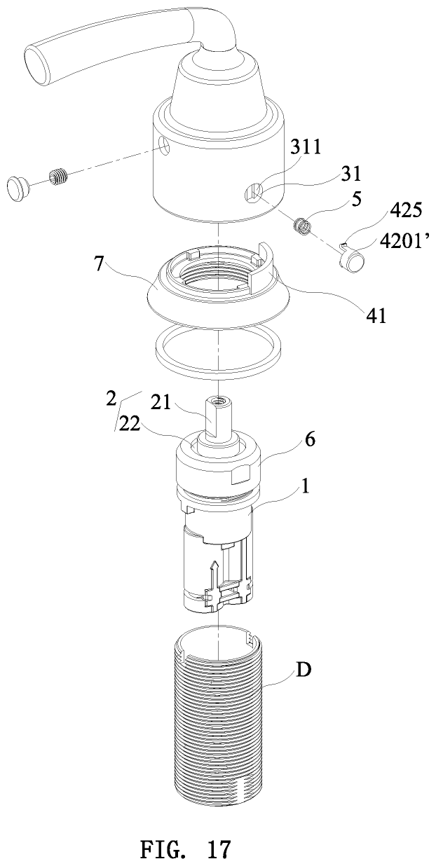

The main difference between the fifth embodiment of the present invention and the first embodiment is the arrangement of the limit member 41. As shown in FIGS. 17 to 19, in the fifth embodiment of the present invention, the safety switching valve B0 further includes a retaining cover 7. The limit member 41 is fixedly disposed on the retaining cover 7. The retaining cover 7 is fixed to the switching valve seat 1. The retaining cover 7 is threadedly connected to an externally threaded sleeve E and presses the switching valve seat 1 for installing the switching valve seat 1 to the externally threaded sleeve E.

### Sixth Embodiment

The main difference between the sixth embodiment of the present invention and the first embodiment lies in the structural difference of the safety switching valve B0.

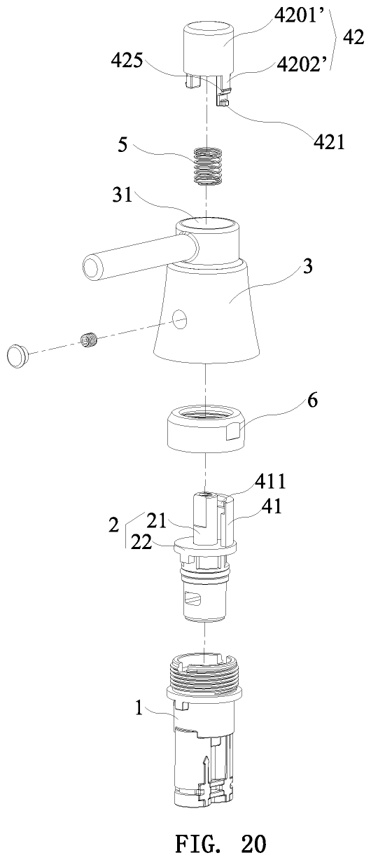

Specially, as shown in FIGS. 20 to 23, in the sixth embodiment of the present invention, the mounting hole 31 of the handle 3 is disposed on the top of the handle 3. The operating member 42 is slidably connected to the mounting hole 31 to be moved up and down. The limit member 41 is arranged lower than the operating member 42. The upper and lower ends of the return spring 5 abut against the operating member 42 and the handle 3, respectively. Through the arrangement of the present invention, the limit position is lower than the release position, and the operating member 42 can be moved up and down to be switched between the limit position and the release position. The return spring 5 can drive the operating member 42 to move up to the limit position.

In the sixth embodiment of the present invention, the inside of the handle 3 is provided with a connecting portion 33 connected to the valve stein 21 of the switching valve core 2. The connecting portion 33 is fixed to the valve stein 21 of the switching valve core 2 by a screw. The connecting portion 33 of the handle 3 may be connected to the side wall of the handle 3 through ribs. The upper and lower ends of the return spring 5 abut against the operating member 42 and the connecting portion 33 of the handle 3, respectively. The operating member 42 may be formed with a spring engaging groove 424 to receive the upper end of the return spring 5, so as to prevent the return spring 5 from shifting.

In the sixth embodiment of the present invention, the operating member 42 may include a button 4201′ and an engaging claw 4202′ that are connected. In this way, the operating member 42 is divided into two parts to facilitate the operating member 42 to be mounted to the handle 3. The upper and lower ends of the return spring 5 abut against the button 4201′ and the stop edge 311, respectively. The button 4201′ may be formed with a spring engaging groove 424 to receive the upper end of the return spring 5, so as to prevent the return spring 5 from shifting. The engaging claw 4202′ may include two engaging claws 4202′. The end of one of the engaging claws 4202′ is provided with the rotation stopper 421. The engaging claws 4202′ may be integrally formed with the button 4201′. In addition, the operating member 42 may be provided with a stop block 425 to abut against the inner side of the side wall of the handle 3, so as to prevent the operating member 42 from being separated from the handle 3. The stop block 425 may be disposed on the engaging claw 4202′.

In the sixth embodiment of the present invention, the limit member 41 is fixedly disposed on the top of the valve housing 22 of the switching valve core 2. The limit member 41 may be integrally formed with the top of the valve housing 22. The limit member 41 may be formed with an arc groove 411 for the rotation stopper 421 to slide in the arc groove 411. When the operating member 42 is moved down to the release position, the rotation stopper 421 of the operating member 42 faces the arc groove 411, so that the restriction on the rotation of the handle 3 of the safety switching valve B0 is released.

### Seventh Embodiment

The main difference between the seventh embodiment of the present invention and the first embodiment lies in the structural difference of the safety switching valve B0 and the difference of the water delivery member C.

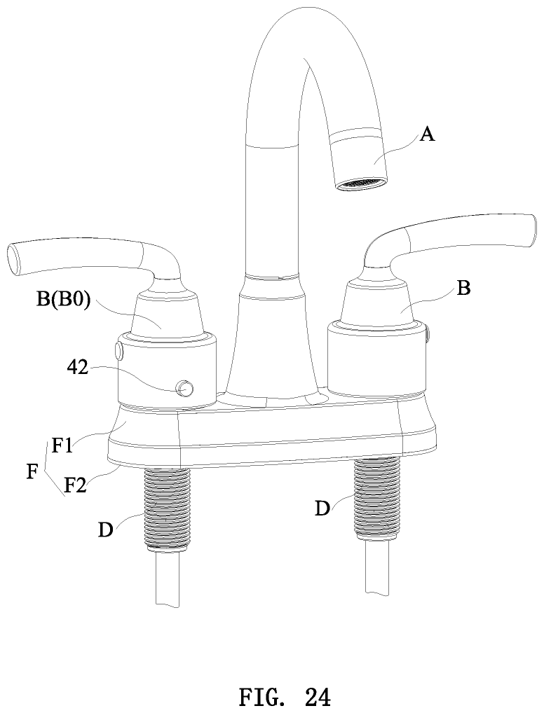

As shown in FIGS. 24 to 27, in the seventh embodiment of the present invention, the outlet ends of two switching valves B are connected to two inlets of a three-way connector C3, respectively. The inlet end of a faucet spout A is connected to the outlet of the three-way connector C3 through an outlet pipe C2. The two switching valves B and the faucet spout A are installed on a casing F. The casing F is configured to cover the two switching valves B and the three-way connector C3. The casing F is composed of an upper cover F1 and a base F2. The two switching valves B are installed on two externally threaded sleeves D, respectively. The two externally threaded sleeves D are connected by a bottom plate D1. The bottom plate D1 is fastened to the upper cover F1 by screws, so that the two switching valves B are fixedly fitted to the casing F.

In the seventh embodiment of the present invention, the valve cover 6 is threadedly connected to the externally threaded sleeve D1 and presses the switching valve core 2 so as to confine the switching valve core 2 on the switching valve seat 1. The valve stein 21 of the switching valve core passes through the valve cover 6.

In the seventh embodiment of the present invention, the mounting hole 31 of the handle 3 is disposed on the side wall of the handle 3. The operating member 42 is slidably connected to the mounting hole 31. The operating member 42 is movable along the axial direction of the mounting hole 31. The inner and outer ends of the return spring 5 abut against the handle 3 and the operating member 42, respectively. Through the arrangement of the present invention, the operating member 42 is movable along the axial direction of the mounting hole 31 to be switched between the limit position and the release position. The return spring 5 can drive the operating member 42 to move to the limit position.

In the seventh embodiment of the present invention, the inner wall of the mounting hole 31 of the handle 3 is provided with a stop edge 311. The inner and outer ends of the return spring 5 abut against the stop edge 311 and the operating member 42, respectively.

In the seventh embodiment of the present invention, the operating member 42 may include a button 4201′ and an engaging claw 4202′ that are connected. In this way, the operating member 42 is divided into two parts to facilitate the operating member 42 to be mounted to the handle 3. The inner and outer ends of the return spring 5 abut against the stop edge 311 of the handle 3 and the button 4201′, respectively. The button 4201′ may be formed with a spring engaging groove 424 to receive the outer end of the return spring 5, so as to prevent the return spring 5 from shifting. The engaging claw 4202′ may include two engaging claws 4202′. The end of one of the engaging claws 4202′ is provided with the rotation stopper 421. The engaging claws 4202′ may be integrally formed with the button 4201′. In addition, the operating member 42 may be provided with a stop block 425 to abut against the inner side of the side wall of the handle 3, so as to prevent the operating member 42 from being separated from the handle 3. The stop block 425 may be disposed on the engaging claw 4202′.

In the seventh embodiment of the present invention, the limit member 41 is fixedly disposed on the casing F. The limit member 41 may be integrally formed with the upper cover F1 of the casing F, so that there is no need to provide a connecting structure between the limit member 41 and the casing F.

Although particular embodiments of the present invention have been described in detail for purposes of illustration, various modifications and enhancements may be made without departing from the spirit and scope of the present invention. Accordingly, the present invention is not to be limited except as by the appended claims

What is claimed is:

1. A misoperation prevention structure of a two-handle faucet, comprising a faucet spout and two switching valves for controlling water to be delivered to the faucet spout;
at least one of the two switching valves being equipped with a misoperation prevention mechanism, the switching valve equipped with the misoperation prevention mechanism being defined as a safety switching valve;
the safety switching valve including a switching valve seat, a switching valve core, a handle, and the misoperation prevention mechanism;
the handle, the switching valve core and the switching valve seat being arranged in sequence in an upper-to-lower direction, the switching valve core being mounted to the switching valve seat, the handle being connected to a valve stein of the switching valve core, the handle and the valve stein of the switching valve core rotating in synchronization with each other;
the misoperation prevention mechanism including a limit member that is not rotatable relative to a valve housing of the switching valve core and an operating member that is movably fitted to the handle, the operating member being in movable cooperation with the limit member.

2. The misoperation prevention structure of the two-handle faucet as claimed in claim 1, wherein the handle is formed with a mounting hole, the operating member is slidably connected to the mounting hole, the operating member is movable between a limit position and a release position, the operating member is provided with a rotation stopper that is in movable cooperation with the limit member;
when the operating member is moved to the limit position, the rotation stopper of the operating member cooperates with the limit member to form a rotation limit; when the operating member is moved to the release position, the rotation stopper of the operating member cooperates with the limit member to release the rotation limit;
a return spring being fitted between the handle and the operating member, and the return spring is configured to drive the operating member to move to the limit position.

3. The misoperation prevention structure of the two-handle faucet as claimed in claim 2, wherein the mounting hole of the handle is disposed on a side wall of the handle; the operating member is slidably connected to the mounting hole to be moved up and down; the limit member is arranged lower than the operating member, upper and lower ends of the return spring abut against the handle and the operating member, respectively.

4. The misoperation prevention structure of the two-handle faucet as claimed in claim 2, wherein the mounting hole of the handle is disposed on a side wall of the handle; the operating member is slidably connected to the mounting hole, the operating member is movable along an axial direction of the mounting hole; inner and outer ends of the return spring abut against the handle and the operating member, respectively.

5. The misoperation prevention structure of the two-handle faucet as claimed in claim 4, wherein an inside of the handle is provided with a connecting portion connected to the valve stein of the switching valve core; the inner and outer ends of the return spring abut against the connecting portion of the handle and the operating member, respectively.

6. The misoperation prevention structure of the two-handle faucet as claimed in claim 2, wherein the mounting hole of the handle is disposed on a top of the handle; the operating member is slidably connected to the mounting hole to be moved up and down; the limit member is arranged lower than the operating member; upper and lower ends of the return spring abut against the operating member and the handle, respectively.

7. The misoperation prevention structure of the two-handle faucet as claimed in claim 6, wherein the limit member is formed with an arc groove for the rotation stopper to slide in the arc groove; when the operating member is moved down to the release position, the rotation stopper of the operating member faces the arc groove.

8. The misoperation prevention structure of the two-handle faucet as claimed in claim 6, wherein an inside of the handle is provided with a connecting portion connected to the valve stein of the switching valve core; the upper and lower ends of the return spring abut against the operating member and the connecting portion of the handle, respectively.

9. The misoperation prevention structure of the two-handle faucet as claimed in claim 2, wherein the return spring is a conical spring.

10. The misoperation prevention structure of the two-handle faucet as claimed in claim 1, wherein the limit member is fixedly disposed on the valve housing of the switching valve core.

11. The misoperation prevention structure of the two-handle faucet as claimed in claim 10, wherein the limit member is fixedly disposed on a top of the valve housing of the switching valve core.

12. The misoperation prevention structure of the two-handle faucet as claimed in claim 1, wherein the safety switching valve further includes a retaining cover, the retaining cover is threadedly connected to an externally threaded sleeve and presses the switching valve seat for installing the switching valve seat to the externally threaded sleeve; the limit member is fixedly disposed on the retaining cover.

13. The misoperation prevention structure of the two-handle faucet as claimed in claim 1, wherein the two switching valves and the faucet spout are installed on a casing; the limit member is fixedly disposed on the casing.
